(19) United States
(12) Patent Application Publication
(10) Pub. No.: US 2025/0312223 A1
(43) Pub. Date: Oct. 9, 2025

(54) Adjustable Neck Alignment Clamp

(71) Applicant: Brandon Romero, New Iberia, LA (US)

(72) Inventor: Brandon Romero, New Iberia, LA (US)

(21) Appl. No.: 18/625,367

(22) Filed: Apr. 3, 2024

(51) Int. Cl. A61H 1/00

(52) U.S. Cl. CPC A61H 1/008; A61H 2201/0192; A61H 2201/1611; A61H 2201/165; A61H 2201/169; A61H 2205/04

(57) ABSTRACT

An adjustable neck alignment clamp includes a C-shaped clamp body and an adjustable support assembly. The C-shaped clamp body includes a curved portion positionable at the nape of a neck of a user and a pair of side portions extending from the curved portion. The adjustable support assembly includes a plurality of reinforcement members positioned in the clamp body and an adjustment mechanism positioned at the curved portion and operatively connected to the reinforcement members. The reinforcement members include a pair of width adjustment members connected to the pair of side portions and relatively movable by the adjustment mechanism to tighten or loosen the clamp body to exert a therapeutic compressive force on cervical vertebrae of a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to neck alignment devices and more particularly pertains to a new adjustable neck alignment clamp for providing a therapeutic compressive force on the neck of a user to align cervical vertebrae and relieve stress on neck muscles and tissue.

### (2) Description of Related Art Including Information Disclosed Under 37 CFR 1.97 and 1.98

The prior art relates to neck alignment devices. The prior art, as best understood, does not disclose an adjustable neck alignment clamp that is tightenable to provide a therapeutic compressive force on the neck of a user to align cervical vertebrae and relieve stress on neck muscles and tissue.

### BRIEF SUMMARY OF THE INVENTION

An embodiment of the disclosure meets the needs presented above in a adjustable neck alignment clamp generally comprising C-shaped clamp body and an adjustable support assembly. The C-shaped clamp body includes a curved portion positionable at the nape of a neck of a user and a pair of side portions extending from the curved portion. The adjustable support assembly includes a plurality of reinforcement members positioned in the clamp body and an adjustment mechanism positioned at the curved portion and operatively connected to the reinforcement members. The reinforcement members include a pair of width adjustment members connected to the pair of side portions and relatively movable by the adjustment mechanism to tighten or loosen the clamp body to exert a compressive force on cervical vertebrae of a user. The tightening and loosening is accomplished by moving at least part of the side portions closer together or further apart to decrease or increase the width of the opening between the side portions. The adjustment mechanism includes a rotatable knob projecting from an outer surface of the curved portion which may be grasped by a user to adjust the compressive force.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of an adjustable neck alignment clamp in use according to an embodiment of the disclosure.

FIG. 2 is a top view of an embodiment of the disclosure.

FIG. 3 is a front view of an embodiment of the disclosure.

FIG. 4 is a rear view of an embodiment of the disclosure.

FIG. 5 is a top cross-sectional view of an embodiment of the disclosure.

FIG. 6 is a side cross-sectional view of an embodiment of the disclosure.

### DETAILED DESCRIPTION OF THE INVENTION

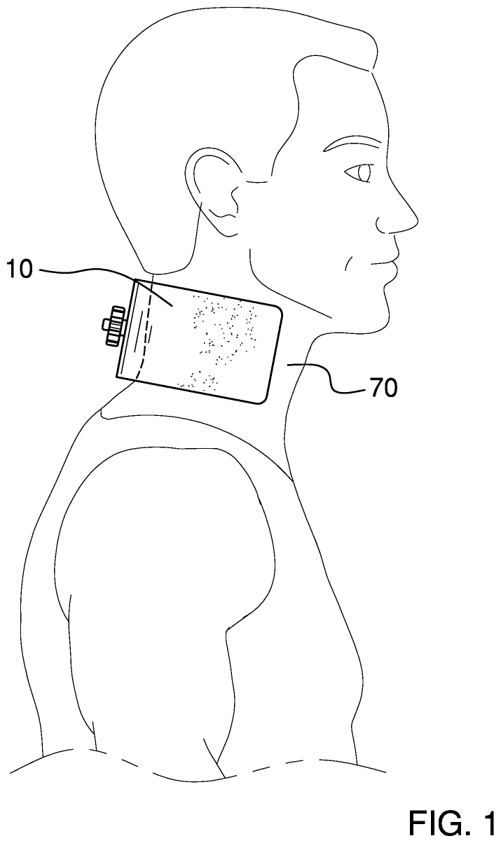

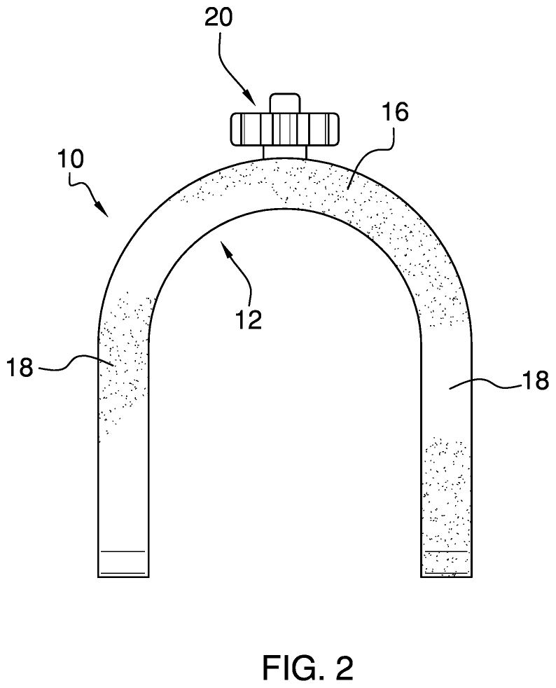

With reference now to the drawings, and in particular to FIGS. 1 through 6 thereof, a new adjustable neck alignment clamp embodying the principles and concepts of an embodiment of the disclosure and generally designated by the reference numeral 10 will be described.

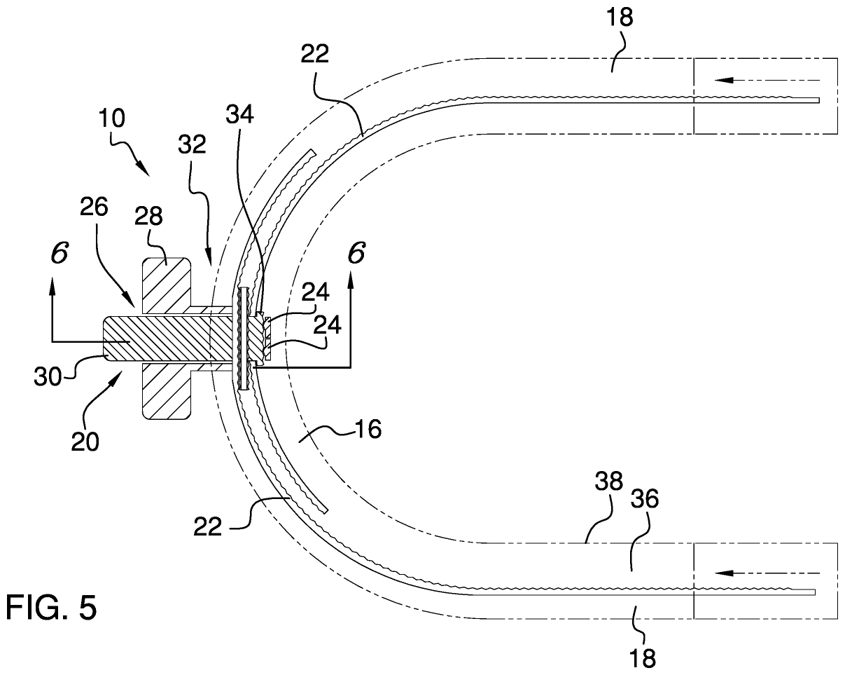

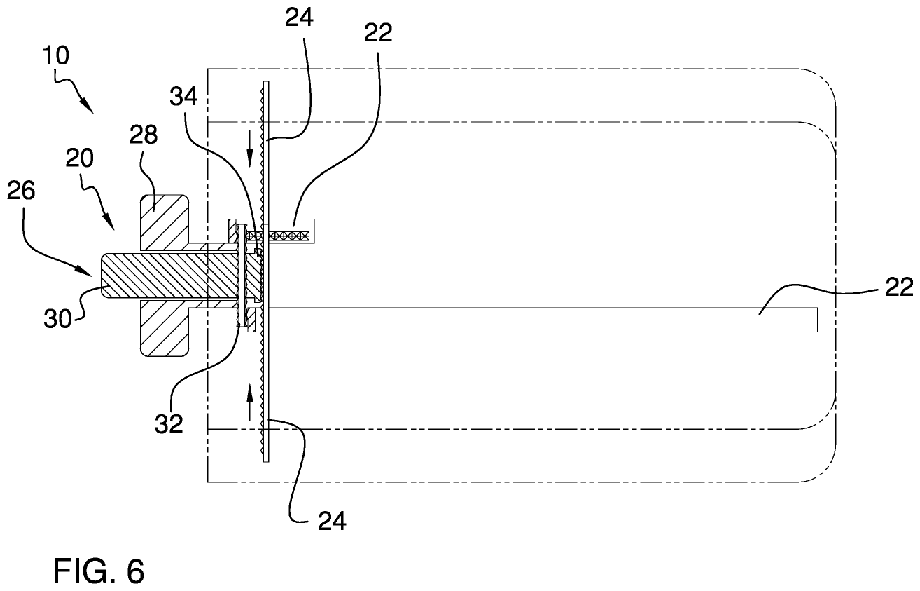

As best illustrated in FIGS. 1 through 6, the adjustable neck alignment clamp 10 generally comprises a C-shaped clamp body 12 and an adjustable support assembly 14. The clamp body 12 includes a curved portion 16 positionable at the nape or back of a neck 70 of a user and a pair of side portions 18 extending from the curved portion 16. The adjustable support assembly 14 includes a plurality of reinforcement members 22, 24 positioned in the clamp body 12 and an adjustment mechanism 20 positioned at the curved portion 16 and operatively connected to the reinforcement members 22, 24. The reinforcement members 22, 24 include a pair of width adjustment members 22 connected to the pair of side portions 18 and relatively movable by the adjustment mechanism 20 to tighten or loosen the clamp body 12 to exert a therapeutic compressive force on cervical vertebrae of a user. The tightening and loosening is accomplished by moving at least part of the side portions 18 closer together or further apart to decrease or increase the width of the opening between the side portions 18. The length of the side portions 18 would also be adjusted, as shown in FIG. 5, as the ends of the width adjustment members 22 are moved back and forth. A compression of the curved portion 16 would also occur. The compression of the clamp body 12 in this manner can also cause the material of the clamp body 12 to bunch up and thereby become thicker around the back of the neck of the user, which results in the clamp body 12 becoming tighter on the back of the neck to exert the compressive force. Therefore, moving the width adjustment members 22 in a retraction movement tightens the clamp body 12 and increases the compressive force, whereas moving them in an extension movement loosens the clamp body 12 and lessens the compressive force. The reinforcement members 22, 24 also include a pair of height adjustment members 24 connected to the curved portion 16 and relatively movable by the adjustment mechanism 20 to adjust the height of the curved portion 16 to fit a neck 70 of a user, as well as at least part of the side portions 18, which height adjustment is shown in FIG. 6. The height reinforcement members 24 can be adjusted to increase and decrease the compressive force on the back of the neck in a similar manner as the width adjustment members 24 described above.

The adjustment mechanism 20 includes a rotatable knob 26 projecting from an outer surface of the curved portion 16 which may be grasped by a user to adjust the compressive force. As seen in FIG. 5, the knob 26 includes a first knob portion 28 operatively connected to the pair of width adjustment members 22 and a second knob portion 30 operatively connected to the pair of height adjustment members 24. The first knob portion 28 and the second knob portion 30 are independently rotatable with respect to one another. This design allows a user to selectively adjust the compressive force by rotating the first knob portion 28 and the height of the curved portion 16 by rotating the second knob portion 30. As seen in FIGS. 5 and 6, the first and second knob portions 28, 30 are coaxial, wherein the second knob portion 30 passes through the interior of the first knob portion 28.

As shown in FIGS. 5 and 6, the adjustable support assembly 14 also includes a first cam gear assembly 32 operatively connecting the first knob portion 28 to the pair of width adjustment members 22 and a second cam gear assembly 34 operatively connecting the second knob portion 30 to the pair of height adjustment members 24. The adjustment mechanism 20 is designed to slip when the clamp body 12 is tightened to exert a compressive force above the selected threshold. To accomplish this slip, the adjustment mechanism 20 could incorporate a torque limiter system that could disengage the first cam gear assembly 32 and the second cam gear assembly 34 to prevent over tightening of either. For example, the first cam gear assembly 32 is designed to slip when the clamp body 12 is tightened to exert a compressive force above a selected threshold, such as by using a torque limiter to disengage the first cam gear assembly 32 from the first knob portion 28. The threshold is in the range of approximately three to five pounds to protect against overtightening, which could be harmful to the user. Alternatively or in addition, the reinforcement members 22, 24 could include mechanical stops 40, such as shown in FIGS. 5 and 6, that would prevent a user from adjusting and moving the reinforcement members 22, 24 past a certain distance by preventing engagement with the respective first cam gear assembly 32 and second cam gear assembly 34. In another possible embodiment, the first cam gear assembly 32 and the second cam gear assembly 34 could have cutouts or stops in the gears themselves to prevent further rotation of the gears past a designated point to also prevent over tightening. In addition, the side portions 18 are of a relatively short length to avoid exerting compression on large arteries at the front of the neck for safety.

It should be noted that the adjustable support assembly 14 shown in the figures is one exemplary embodiment and other mechanical assemblies that permit a user to adjust the compressive force of the clamp body 12 or the height of the curved portion 16 are within the scope of the disclosure. For example, while the reinforcement members 22, 24 are shown as partially curved toothed bands or strips in FIGS. 5 and 6, other designs, such as smooth bands, angular bands with straight portions, and T-shaped structures are within the scope of the disclosure.

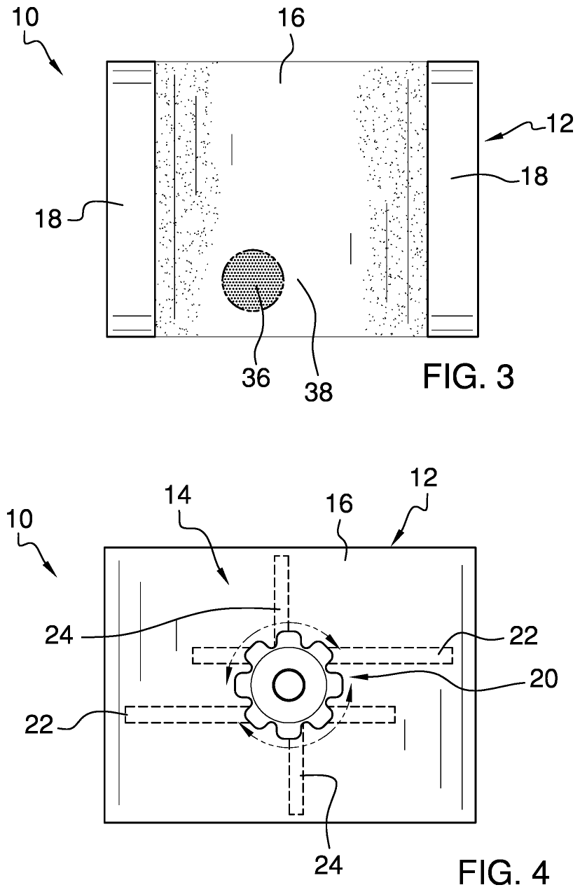

As best seen in FIG. 3, the clamp body 12 includes a base body 36—a portion is exposed in FIG. 3—and a cover layer 38 surrounding the base body 36. The base body 36 is resiliently compressible and stretchable, which allows for the adjustment of the width of the opening and the height of the curved portion 16. The base body 36 could be made of a foam material, such as a memory foam, and the reinforcement members 22, 24 could be partially embedded in the foam material to allow the reinforcement members 22, 24 to compress and expand the base body 36 when they are moved. For example, the reinforcement members 22, 24 could be embedded into the material at their end portions, while the other portions are movable within the foam. While not shown, the end portions of the reinforcement members 22, 24 could include transverse projections or larger heads to better attach the ends to the material. The cover layer 38 could be made of a fleece or soft fabric material that is resiliently compressible and stretchable.

In use, the user places the clamp body 12 on the back of his or her neck 70 as shown in FIG. 1. The user can then rotate the first knob portion 28 to adjust the compressive force to a desired amount below the threshold amount. The compressive force helps align the cervical vertebrae and relieve stresses on the surrounding neck muscles and tissue. The user can also adjust the height of the curved portion 16 to better fit the length of the user's neck 70 by rotating the second knob portion 30. As mentioned above, the user is prevented from overtightening the clamp body 12 by the slipping of the first cam gear assembly 32.

While the adjustable neck alignment clamp 10 is described herein in relation to therapeutic compressive treatment of the neck, it would be possible to use the alignment clamp 10 on other parts of the body, such as parts of the arms and legs, such as biceps, forearms, thighs, and calves, to exert pressure on those parts of the body in a similar manner as the neck. The alignment clamp 10 for the neck could be used, or it could be re-sized for the other parts of the body, such as possibly larger or smaller.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An adjustable neck alignment clamp comprising:
a C-shaped clamp body comprising a curved portion positionable at the nape of a neck of a user and a pair of side portions extending from said curved portion; and
an adjustable support assembly comprising a plurality of reinforcement members disposed in said clamp body and an adjustment mechanism disposed at said curved portion and operatively connected to said reinforcement members, wherein said reinforcement members comprise a pair of width adjustment members connected to said pair of side portions and relatively movable by said adjustment mechanism to tighten or loosen said clamp body to exert a compressive force on cervical vertebrae of a user.

2. The adjustable neck alignment clamp of claim 1, wherein said adjustment mechanism comprises a rotatable knob projecting from an outer surface of said curved portion.

3. The adjustable neck alignment clamp of claim 2, wherein said reinforcement members comprise a pair of height adjustment members connected to said curved portion and relatively movable by said adjustment mechanism to adjust the height of said curved portion to fit a neck of a user.

4. The adjustable neck alignment clamp of claim 3, wherein said knob comprises a first knob portion operatively connected to said pair of width adjustment members and a second knob portion operatively connected to said pair of height adjustment members, wherein said first knob portion and said second knob portion are independently rotatable with respect to one another.

5. The adjustable neck alignment clamp of claim 4, wherein said adjustable support assembly comprises a first cam gear assembly operatively connecting said first knob portion to said pair of width adjustment members and a second cam gear assembly operatively connecting said second knob portion to said pair of height adjustment members.

6. The adjustable neck alignment clamp of claim 5, wherein said first cam gear assembly is configured to slip when said clamp body is tightened to exert a compressive force above a selected threshold.

7. The adjustable neck alignment clamp of claim 6, wherein said threshold is in the range of approximately three to five pounds.

8. The adjustable neck alignment clamp of claim 1, wherein said adjustment mechanism is configured to slip when said clamp body is tightened to exert a compressive force above a selected threshold.

9. The adjustable neck alignment clamp of claim 8, wherein said threshold is in the range of approximately three to five pounds.

10. The adjustable neck alignment clamp of claim 1, wherein said clamp body comprises a base body and a cover layer surrounding said base body, and said base body is resiliently compressible and stretchable.

11. The adjustable neck alignment clamp of claim 10, wherein said base body comprises a foam material, and said reinforcement members are partially embedded in said foam material.

12. The adjustable neck alignment clamp of claim 10, wherein said cover layer comprises a fleece or soft fabric material that is resiliently compressible and stretchable.

13. A method of using the adjustable neck alignment clamp of claim 2 comprising:
placing said clamp body on the neck of a user with said curved portion at the nape of the neck and said pair of side portions extending along the sides of the neck; and
adjusting said adjustable support assembly by rotating said knob and relatively moving said width adjustment members to tighten said clamp body to exert a compressive force on cervical vertebrae of a user.

14. An adjustable neck alignment clamp comprising:
a C-shaped clamp body comprising a curved portion positionable at the nape of a neck of a user and a pair of side portions extending from said curved portion;
an adjustable support assembly comprising a plurality of reinforcement members disposed in said clamp body and an adjustment mechanism disposed at said curved portion and operatively connected to said reinforcement members, said reinforcement members comprising a pair of width adjustment members connected to said pair of side portions and relatively movable by said adjustment mechanism to tighten or loosen said clamp body to exert a compressive force on cervical vertebrae of a user, said reinforcement members comprise a pair of height adjustment members connected to said curved portion and relatively movable by said adjustment mechanism to adjust the height of said curved portion to fit a neck of a user;
said adjustment mechanism comprises a rotatable knob projecting from an outer surface of said curved portion, said knob comprises a first knob portion operatively connected to said pair of width adjustment members, said knob comprises a second knob portion operatively connected to said pair of height adjustment members, wherein said first knob portion and said second knob portion are independently rotatable with respect to one another,
said adjustable support assembly comprises a first cam gear assembly operatively connecting said first knob portion to said pair of width adjustment members, said first cam gear assembly is configured to slip when said clamp body is tightened to exert a compressive force above a selected threshold, said threshold is in the range of approximately three to five pounds, said adjustable support assembly comprises a second cam gear assembly operatively connecting said second knob portion to said pair of height adjustment members; and
said clamp body comprises a base body and a cover layer surrounding said base body, said base body comprises a solid material that is resiliently compressible and stretchable, said cover layer comprises a fleece or soft fabric material that is resiliently compressible and stretchable, said base body comprises a foam material, said reinforcement members are partially embedded in said foam material.
